(19) United States
(12) Patent Application Publication
(10) Pub. No.: US 2020/0116513 A1
(43) Pub. Date: Apr. 16, 2020

(54) INFORMATION PROCESSING APPARATUS, INFORMATION PROCESSING METHOD, AND INFORMATION PROCESSING SYSTEM

(71) Applicant: SONY CORPORATION, TOKYO (JP)

(72) Inventor: ATSUSHI SHIONOZAKI, TOKYO (JP)

(21) Appl. No.: 16/619,141

(22) PCT Filed: Apr. 4, 2018
(86) PCT No.: PCT/JP2018/014355

§ 371 Date: Dec. 4, 2019

(30) Foreign Application Priority Data
Jun. 13, 2017 (JP) 2017-116004

(51) Int. Cl. G01C 21/34; G09F 9/30

(52) U.S. Cl. CPC G01C 21/3453; G09F 9/30

(57) ABSTRACT

[Object] To provide an information processing apparatus, an information processing method, and an information processing system that make it possible to implement navigation that is safe and less affected by an ambient environment. [Solving Means] The information processing apparatus includes a controller that specifies a second user who travels to a destination that is the same as a destination of a first user, and causes output of identification information for identifying the second user who has been specified.

### TECHNICAL FIELD

The present disclosure relates to an information processing apparatus, an information processing method, and an information processing system.

### BACKGROUND ART

As terminals that make it possible to acquire location information have been spread, navigation systems have been widely used. The navigation systems implement navigation (guiding) to a destination set by a user who uses a terminal, on the basis of the location information. In a case of using such a navigation system, it is necessary to watch a screen of the terminal to check a route to the destination, for example. This may result in distraction of attention from traffic or an obstacle.

Therefore, PTL 1 listed below discloses a mobile terminal that decides a direction of travel on the basis of a route from a current location to a destination and projects the direction onto a projection target such as, for example, ground by using a projector. The technology described in PTL 1 makes it possible to arrive at the destination by following the direction projected on the projection target. This makes it possible to implement safer navigation.

### CITATION LIST

### Patent Literature

PTL 1: Japanese Unexamined Patent Application Publication No. 2004-93358

### SUMMARY OF THE INVENTION

### Problems to be Solved by the Invention

However, the above-described technology using a projector is easily affected by an ambient environment. For example, in a case where there is no appropriate projection target around, or in a case where an ambient environment is too bright, there is a possibility that visibility reduces and it becomes difficult to follow the projected direction.

Therefore, according to the present disclosure, there is proposed an information processing apparatus, an information processing method, and an information processing system that make it possible to implement navigation that is safe and less affected by an ambient environment.

### Means for Solving the Problem

According to the present disclosure, there is provided an information processing apparatus including a controller that specifies a second user who travels to a destination that is same as a destination of a first user, and causes output of identification information for identifying the second user who has been specified.

In addition, according the present disclosure, there is provided an information processing method including: specifying, by a processor, a second user who travels to a destination that is same as a destination of a first user; and causing output of identification information for identifying the second user who has been specified.

In addition, according the present disclosure, there is provided an information processing system including: an information processing apparatus including a controller that specifies a second user who travels to a destination that is same as a destination of a first user, and causes output of identification information for identifying the second user who has been specified; and a terminal that displays the identification information.

### Advantageous Effect of the Invention

As described above, according to the present disclosure, it is possible to implement navigation that is safe and less affected by an ambient environment.

Note that the effects described above are not necessarily limited, and along with or instead of the effects, any effect that is desired to be introduced in the present specification or other effects that can be expected from the present specification may be exhibited.

### BRIEF DESCRIPTION OF THE DRAWINGS

FIG. 1 is an explanatory diagram illustrating an overview of an information processing system according to an embodiment of the present disclosure.

FIG. 2 is an explanatory diagram illustrating a configuration example of an information processing system 1 according to the embodiment.

FIG. 3 is a block diagram illustrating a configuration of a server 10 according to the embodiment.

FIG. 4 is a block diagram illustrating a configuration of a user terminal 20 according to the embodiment.

FIG. 5 is a flowchart illustrating a process flow of operation related to a follower according to the embodiment.

FIG. 6 is an explanatory diagram illustrating a display example of identification information on a user terminal 20A, which is an HMD worn by a user.

FIG. 7 is an explanatory diagram illustrating a display example of identification information on the user terminal 20A, which is the HMD worn by the user.

FIG. 8 is an explanatory diagram illustrating a display example of identification information on the user terminal 20A, which is the HMD worn by the user.

FIG. 9 is an explanatory diagram illustrating a display example of identification information on a user terminal 20B, which is a smartphone.

FIG. 10 is an explanatory diagram illustrating a display example of identification information on the user terminal 20C, which is an on-board apparatus.

FIG. 11 is a flowchart illustrating a process flow of operation related to a leader according to the embodiment.

FIG. 12 is a flowchart illustrating a process flow of operation related to a digital signage apparatus 30 according to the embodiment.

FIG. 13 is an explanatory diagram illustrating a display example of identification information on the digital signage apparatus 30.

FIG. 14 is an explanatory diagram illustrating a hardware configuration example.

### MODES FOR CARRYING OUT THE INVENTION

Hereinafter, preferred embodiments of the present disclosure will be described in detail with reference to the appended drawings. Note that, in this specification and the drawings, structural elements that have substantially the same function and structure are denoted with the same reference signs, and repeated explanation is omitted.

In addition, in this specification and the drawings, sometimes a plurality of structural elements that have substantially the same function and structure may be denoted by the same reference sign followed by different alphabets for distinction purposes. However, in a case where there is no need to particularly distinguish between the plurality of structural elements that have substantially the same function and structure, only the same reference sign is assigned.

Note that, the description will be given in the following order.

### <<1. Overview>>

### <<2. Configuration>>

### <2-1. Configuration of Information Processing System>

### <2-2. Configuration of Server>

### <2-3. Configuration of User Terminal>

### <<3. Operation>>

<3-1. Operation related to Follower>
<3-2. Operation related to Leader>
<3-3. Operation related to Digital signage Apparatus 30>

### <<4. Hardware Configuration Example>>

### <<5. Conclusion>>

### 1. Overview

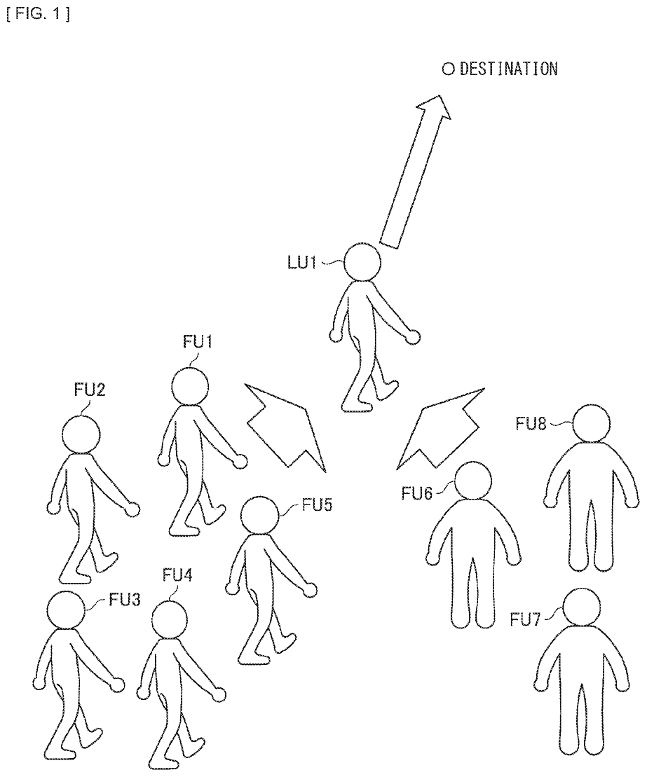

First, with reference to FIG. 1, an overview of an embodiment of the present disclosure will be described. An information processing system according to this embodiment is a system that guides (implements navigation of) a user (first user), who wants to be guided to a destination, to the destination by providing identification information of another user (second user) who travels to the same destination as the first user.

FIG. 1 is an explanatory diagram illustrating an overview of the information processing system according to the embodiment of the present disclosure. The information processing system according to this embodiment makes it possible for follower users FU1 to FU8 (first users) to arrive at a destination by causing the follower users FU1 to FU8 (first users) to follow a leader user LU1 (second user) who travels to the destination. The leader user LU1 is a user who travels to the destination. For example, the leader user LU1 is desirably a user who has visited the destination a predetermined number of times or more, and who knows a route to the destination.

The information processing system according to this embodiment provides identification information for identifying the leader user LU1 to, for example, the follower users FU1 to FU8. This makes it possible to assist the follower users FU1 to FU8 in finding the leader user LU1 to follow, and implement navigation as described above.

The information processing system according to this embodiment makes it possible for the follower users FU1 to FU8 who have found the leader user LU1 to follow, to safely arrive at a destination simply by following the leader user LU1, without watching screens of mobile terminals or the like. In addition, the information processing system according to this embodiment makes it possible to guide the follower users FU1 to FU8 to the destination without being affected by an ambient environment.

This embodiment is particularly effective in a case where many users travel to the same destination. Examples of the many users include users traveling to a gate (destination) in an airport, users traveling from a station to an event venue (destination) where the users have never visited, users traveling to a destination that is a real-life location of a production or a destination related to a game using location information, and the like.

Note that, FIG. 1 illustrates a case where there is only one leader user. However, this embodiment is not limited thereto. For example, there may be a plurality of leader users traveling to the same destination at the same time. In addition, hereinafter, sometimes users related to the information processing system according to this embodiment including the leader users and the follower users may be collectively referred to as users. In addition, hereinafter, sometimes the leader user may be simply referred to as a leader, and the follower user may be simply referred to as a follower.

### 2. Configuration

The overview of the information processing system according to the embodiment of the present disclosure has been described above. Next, a configuration of the information processing system according to this embodiment will be described. Hereinafter, an overall configuration of the information processing system according to this embodiment will be described first, and then configurations of user terminals and a server included in the information processing system according to this embodiment will be described.

### <2-1. Configuration of Information Processing System>

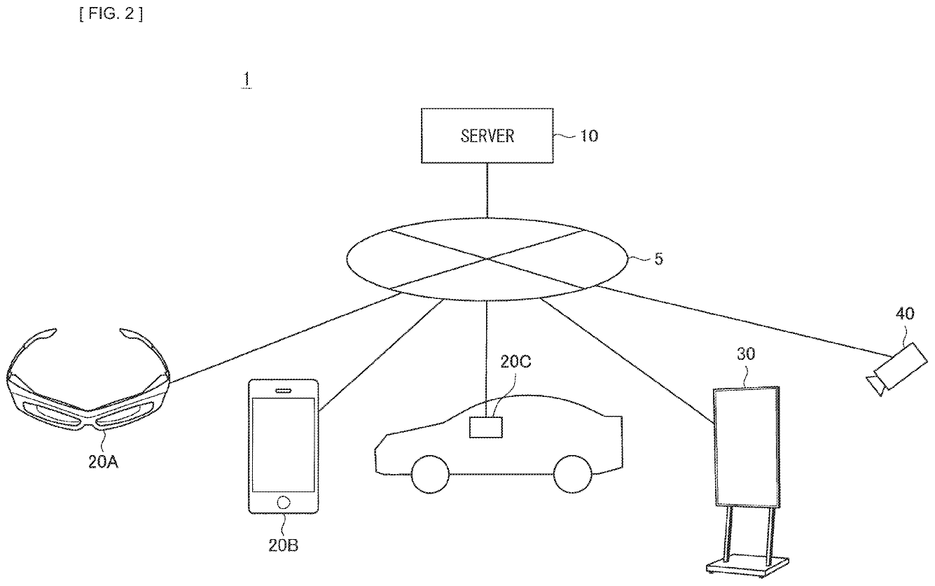

FIG. 2 is an explanatory diagram illustrating a configuration example of an information processing system 1 according to this embodiment. As illustrated in FIG. 2, the information processing system 1 according to this embodiment includes a server 10, user terminals 20A to 20C, a digital signage apparatus 30, and a camera 40. They are coupled to each other via a communication network 5 so as to communicate with each other.

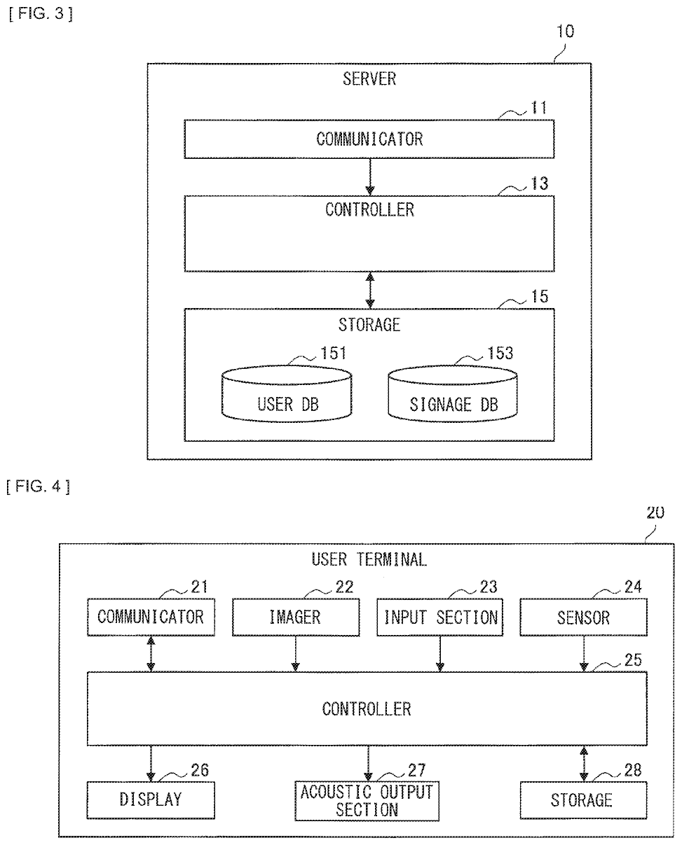

The server 10 is an information processing apparatus that manages the whole information processing system 1. For example, the server 10 according to this embodiment manages information of users, and causes identification information for identifying a leader (a second user) traveling to the same destination as a destination set by the followers (the first users) to be outputted to user terminals 20 held by followers (first users) or the digital signage apparatus 30. The identification information may include, for example, information regarding distances between the followers and the leader, information regarding directions from the followers to the leader, a captured image of the leader, and the like. Such a configuration makes it possible for the followers to find the leader and follow the leader to a destination. Note that, a detailed configuration of the server 10 will be described later with reference to FIG. 3.

The user terminals 20A to 20C are information processing apparatuses held by the users (the followers or the leader). The server 10 may manage the user terminals 20 held by the users in association with the respective users, for example.

The user terminal 20A is a glasses-type head-mounted display (HMD) worn by a user. The user terminal 20B is a smartphone. The user terminal 20B is an on-board apparatus that is installed in a vehicle such as a car. Note that, the user terminals 20 illustrated in FIG. 2 are mere examples. The present technology is not limited thereto. The information processing system 1 may include any type of user terminal 20, and the number of user terminals 20 may be more or less than the number of user terminals 20 illustrated in FIG. 2.

The user terminals 20 include at least a display function and display identification information provided by the server 10. Note that, a detailed configuration of the user terminal 20 will be described later with reference to FIG. 4.

The digital signage apparatus 30 includes at least a display function and display identification information provided by the server 10. The digital signage apparatus 30 may be installed in various locations such as a station, an airport, a side of a road, or a wall of a building, for example.

The camera 40 is an imaging apparatus that provides the server 10 with a captured image of the leader obtained by capturing the image of the leader. The camera 40 may be a so-called live camera or a security camera installed in, for example, a station, an airport, a street, or the like. In addition, the camera 40 may be installed near the digital signage apparatus 30.

The communication network 5 is a wired or wireless communication channel through which information is transmitted from apparatuses or systems coupled to the communication network 5. For example, the communication network 5 may include a public network such as the Internet, a telephone network, or a satellite communication network, various kinds of local area networks (LANs) include Ethernet (registered trademark), a wide area network (WAN), and the like. In addition, the communication network 5 may include a dedicated network such as an Internet Protocol Virtual Private Network (IP-VPN).

### <2-2. Configuration of Server>

The overall configuration example of the information processing system 1 according to this embodiment has been described above. Next, with reference to FIG. 3, a detailed configuration of the server 10 included in the information processing system 1 will be described. FIG. 3 is a block diagram illustrating a configuration of the server 10. As illustrated in FIG. 3, the server 10 is an information processing apparatus including a communicator 11, a controller 13, and a storage 15.

### (Communicator 11)

The communicator 11 is a communication interface that mediates communication between the server 10 and other apparatuses. The communicator 11 supports any wireless or wired communication protocol, and directly couples to the other apparatuses for communication or couples to the other apparatuses for communication via the communication network 5 described above with reference to FIG. 2, for example.

In addition, under the control of the controller 13, the communicator 11 transmits information to the other apparatuses and receives information from the other apparatuses. For example, the communicator 11 may transmit identification information for identifying the leader or a signal for outputting the identification information, to the user terminals 20 and the digital signage apparatus 30. In addition, the communicator 11 may transmit distances to a destination to the user terminals 20 and the digital signage apparatus 30. In addition, the communicator 11 may receive location information and information regarding destinations of the users holding the user terminals 20, from the user terminals 20. In addition, the communicator 11 may receive a captured image of the leader obtained when the camera 40 captures the image of the leader, from the camera 40. Note that, the above-described information to be transmitted and received are mere examples. The present technology is not limited thereto. The communicator 11 may transmit or receive various kinds of information.

### (Controller 13)

The controller 13 controls operation of respective structural elements of the server 10. For example, the controller 13 specifies the leader (the second user) who travels to a destination that is the same as a destination of the followers (the first users) who want to be navigated, and causes output of identification information for identifying the leader who has been specified.

Note that, in this specification, the wording “the output of information” includes, for example, transmission of information, display of information, acoustic output of information, output (vibration output) of information through vibration, and the like.

For example, the controller 13 may control the communicator 11 to transmit (output) information to other apparatuses.

In addition, the controller 13 may cause display (output) of information by generating a display control signal for displaying the information on another apparatus (such as the user terminal 20 or the digital signage apparatus 30) and controlling the communicator 11 to transmit the display control signal to the other apparatus. The controller 13 may cause acoustic output of information by generating an acoustic signal for acoustically outputting the information from another apparatus and controlling the communicator 11 to transmit the acoustic signal to the other apparatus. The controller 13 may cause vibration output of information by generating a signal for outputting the information from another apparatus through vibration and controlling the communicator 11 to transmit the signal to the other apparatus.

For example, the controller 13 may cause identification information to be outputted to the user terminals 20 associated with the followers. The user terminals 20 associated with the followers may be, for example, user terminals 20 held by the followers. Information regarding the association between the users and the user terminals 20 held by the users may be stored in, for example, a user DB 151 stored in the storage 15 (to be described later).

Such a configuration makes it possible for the user terminals 20 held by the followers to display identification information. This makes it possible for the followers to find the leader and follow the leader to the destination.

In addition, the controller 13 may cause identification information to be outputted to the digital signage apparatus 30. For example, the controller 13 may cause the identification information to be outputted to a digital signage apparatus 30 installed near a follower, on the basis of location information of the digital signage apparatuses 30 and location information received from the user terminal 20 held by the follower. Note that, the location information of the digital signage apparatuses 30 may be stored in, for example, a signage DB 153 stored in the storage 15 (to be described later). Such a configuration makes it possible for the follower to find the leader more easily.

The identification information caused to be outputted by the controller 13 may include, for example, information regarding distances between the followers and the leader. A distance between a follower and the leader may be specified on the basis of, for example, location information received from a user terminal 20 held by the follower and location information received from a user terminal 20 held by the leader. Such a configuration makes it possible for the followers to find the leader more easily. In addition, in a case of outputting identification information regarding a plurality of leaders (to be described later), it is possible for a follower to find a leader more easily by, for example, preferentially finding the leader closer to the follower.

In addition, the identification information caused to be outputted by the controller 13 may include information regarding directions toward the leader obtained when seen by the followers. A direction toward the leader obtained when seen by a follower may be specified on the basis of, for example, location information received from a user terminal 20 held by the follower and location information received from a user terminal 20 held by the leader. Such a configuration makes it possible for the followers to find the leader more easily.

In addition, the identification information caused to be outputted by the controller 13 may include a captured image of the leader obtained by capturing the image of the leader. The captured image of the leader may be preliminarily stored in, for example, the user DB 151 stored in the storage 15 (to be described later). In addition, the image of the leader may be captured by, for example, the camera 40, and may be received from the camera 40. Note that, in a case where the image of the leader is captured by the camera 40, for example, the controller 13 may cause transmission of information for requesting the camera 40 installed near the leader to transmit the captured image of the leader on the basis of location information received from the user terminal 20 held by the leader. Such a configuration makes it possible for the followers to find the leader more easily.

The controller 13 may specify a plurality of leaders traveling to a destination that is the same as a destination of the followers, as leaders related to output of identification information, or may specify a single leader as a leader related to output of identification information. Information regarding the destination of the followers may be received by the communicator 11 from, for example, the user terminals 20 held by the followers. In addition, information regarding the destination of the leader may be received by the communicator 11 from, for example, the user terminal 20 held by the leader.

The controller 13 may specify all leaders traveling to a destination that is the same as a destination of the followers, and may cause output of identification information regarding all the leaders. According to the above-described configuration, it is only necessary for the followers to find any leader among all the leaders traveling to the same destination. This makes it possible to find the leader more easily.

In addition, the controller 13 may specify a leader related to output of identification information on the basis of a distance from a follower. For example, the controller 13 may specify one or a plurality of leaders close to a follower, and cause output of identification information regarding the specified leader(s) close to the follower. According to the above-described configuration, in a case where there are many leaders traveling to a destination that is the same as a destination of a follower, for example, it is possible for the follower to check only identification information regarding a leader close to the follower. This makes it possible to find the leader more efficiently.

In addition, the controller 13 may specify a leader related to output of identification information on the basis of a selection made by a follower. For example, the follower may select one or a plurality of leaders by using a user terminal 20 held by the follower.

For example, in a case where the follower who has checked simple identification information regarding a plurality of leaders displayed on the user terminal 20 selects one or a plurality of the leaders to check detailed identification information, the controller 13 may cause output of the detailed identification information regarding the selected leader(s). Note that, the simple identification information may be, for example, information regarding distances between the follower and the leaders, or information regarding directions toward the leaders obtained when seen by the follower. The detailed identification information may be, for example, captured images of the leaders. Such a configuration makes it possible for the follower to find the leader more efficiently.

In addition, the controller 13 may cause information (such as a screen) for prompting evaluation of the leader to be outputted to the user terminals 20 associated with the followers. A timing of prompting evaluation of the leader may be, for example, a timing immediately after a follower arrives at a destination, or a timing after a predetermined period of time elapses from when the follower has arrived at the destination. In a case where the leader is evaluated by the follower, the communicator 11 may receive an evaluation result of the leader from the user terminal 20, and the controller 13 may store the evaluation result of the leader in the user DB 151 stored in the storage 15, without any process or after statistically processing the evaluation result.

In addition, the controller 13 may cause information regarding the evaluation of the leader to be outputted to the user terminal 20 associated with the follower. The outputted information regarding the evaluation of the leader may be, for example, information regarding past evaluation of the leader. For example, in a case where the leader is evaluated on the basis of a score (a numerical value), the information regarding evaluation of the leader may include statistical data such as an average value, a median, or a sum of past scores. In addition, the outputted information regarding evaluation of the leader may include information regarding the number of followers who have been guided by the leader to destinations in the past. Such a configuration makes it possible for the follower to preferentially select or find a highly evaluated leader when the follower selects or finds a leader to follow from among a plurality of leaders.

Note that, the information regarding the evaluation of the leader may be used for purposes other than the above-described purposes. For example, the leader may get an incentive depending on information regarding evaluation of the leader. The incentive given to the leader may be based on a service or a location linked to the information processing system 1. For example, the incentive may be shopping points usable in stores in an airport, frequent flier points, or points in a game. For example, the leader may get the incentive depending on the number of followers guided by the leader to destinations in the past, or an average value, a median, a sum, or the like of scores. Such a configuration makes it possible to give the leader a benefit of guiding followers to destinations as a leader. This makes it possible to expect the leader to travel more accurately.

In addition, in a case where a distance between a follower and the leader is too long, the controller 13 may cause information notifying that the distance to the leader is too long to be outputted to the user terminal 20 associated with the follower. It may be determined whether or not the distance between the follower and the leader is too long, on the basis of location information of the user terminal 20 associated with the follower and location information of the user terminal 20 associated with the leader. Note that, in a case of issuing such a notification, it is highly possible that the follower does not watch the screen of the user terminal 20. Therefore, instead of or in addition to displaying of the notification, it is desirable to output the notification acoustically or vibrationally.

In a case where the controller 13 causes output of identification information regarding the plurality of leaders, the controller 13 may determine that a distance between a follower and a leader is too long when, for example, the leader is not included in a range of a predetermined distance from the follower.

Alternatively, in a case where the controller 13 causes output of identification information regarding a single leader, it may be determined that a distance between a follower and the leader is too long when, for example, the distance between the follower and the single leader becomes a predetermined threshold or more. For example, as described above, in a case where the controller 13 causes output of identification information regarding a single leader who is specified on the basis of a distance from a follower or on the basis of a selection made by the follower, such a determination may be made on the basis of the distance between the follower and the leader.

Such a configuration makes it possible for the follower to recognize that a distance to a leader to follow is too long.

In addition, in a case where a distance between a follower and a leader is too long, the controller 13 may specify a leader again and cause output of identification information for identifying the specified leader. The specified leader may be the leader who has been specified the last time, or another leader. Such a configuration makes it possible for the follower to find a leader again on the basis of identification information outputted again, even in a case where a distance between the follower and a leader is too long and, for example, the follower loses the leader.

The leader specified by the controller 13 may be a user who satisfies a predetermined condition for becoming a leader. The predetermined condition may include, for example, a predetermined number of visits to the destination. The number of visits to the destination may be specified on the basis of a history of location information received from the user terminal 20 held by the user, a past navigation history, or the like, or may be preliminarily stored in the user DB 151 stored in the storage 15 in association with the user, for example. Such a configuration makes it possible to specify a user who knows a route to the destination, as the leader.

In addition, the predetermined condition may include a condition regarding past evaluation of the leader. For example, the predetermined condition may include a condition regarding the number of followers guided by the user to destinations in the past, or an average value, a median, a sum, or the like of scores obtained in the past. Such a configuration makes it highly possible to specify a user who is highly evaluated in the past, as the leader.

In addition, the controller 13 may prompt a user who satisfies the above-described predetermined condition to be a leader, by causing information notifying that the predetermined condition is satisfied to be outputted to a user terminal 20 associated with the user who satisfies the above-described predetermined condition out of users traveling to a destination. For example, in a case where a user sets a destination by using his/her user terminal 20, the controller 13 may determine whether or not the user satisfies the above-described predetermined condition. Next, in a case where the user satisfies the above-described predetermined condition, the controller 13 may cause information for notifying that the predetermined condition is satisfied to be outputted to the user terminal 20, and prompt the user to be the leader.

In addition, the controller 13 may set the user as the leader in a case where the user is selected as the leader through the user terminal 20 and the communicator 11 receives information regarding the selection from the user terminal 20. For example, the controller 13 may set the user as the leader by turning on a leader flag regarding the user. Note that, the leader flag is a flag indicating whether or not the user is currently set as the leader. For example, such flags may be stored in the user DB 151 stored in the storage 15, and may be managed for respective users. Such a configuration makes it possible to prompt a user suitable to guide other users (followers) to become a leader.

Note that, a method of setting a user as a leader is not limited thereto. For example, it is possible for the user to voluntarily select himself/herself as the leader (request that the user himself/herself be set as the leader). Next, in a case where the communicator 11 receives information regarding such a selection from the user terminal 20, the controller 13 may set the user as the leader. Such a configuration makes it possible to set, as a leader, a user sufficiently knowing a route to a destination although the user does not satisfy the above-described condition because, for example, the user is just registered or the like.

In addition, in a case where the leader deviates too much from the route to destination, the controller 13 may cause information notifying that the leader deviates too much from the route to the destination to be outputted to the user terminal 20 associated with the leader. The route to the destination may be specified by using a known technology on the basis of the destination and location information of the user terminal 20 obtained when the leader has set the destination. In addition, it may be determined whether or not the leader deviates too much from the route to the destination, on the basis of the route and current location information of the user terminal 20, for example. Note that, in a case of issuing such a notification, it is highly possible that the leader does not watch the screen of the user terminal 20. Therefore, instead of or in addition to displaying of the notification, it is desirable to output the notification acoustically or vibrationally.

### (Storage 15)

The storage 15 stores programs and data to be used for operation of the server 10. For example, as illustrated in FIG. 3, the storage 15 stores the user DB 151 and the signage DB 153 that are referred to by the controller 13.

The user DB 151 stores information regarding users. The information regarding users stored in the user DB 151 may include, for example, information regarding association between the users and the user terminals 20 held by the users, captured images, information regarding evaluation, visit histories, leader flags, or the like.

In addition, the signage DB 153 stores information regarding the digital signage apparatuses 30. For example, the information regarding the digital signage apparatuses 30 stored in the signage DB 153 may include, for example, location information of the respective digital signage apparatuses 30, information indicating whether or not the respective leaders permit display of information on the digital signage apparatuses 30, or the like.

### <2-3. Configuration of User Terminal>

FIG. 4 is a block diagram illustrating a configuration of the user terminal 20. As illustrated in FIG. 4, the user terminal 20 is an information processing apparatus including a communicator 21, an imager 22, an input section 23, a sensor 24, a controller 25, a display 26, an acoustic output section 27, and a storage 28.

### (Communicator 21)

The communicator 21 is a communication interface that mediates communication between the user terminal 20 and another apparatus. The communicator 21 supports any wireless or wired communication protocol, and directly couples to the other apparatus for communication or couples to the other apparatus for communication via the communication network 5 described above with reference to FIG. 2, for example.

In addition, under the control of the controller 25, the communicator 21 transmits information to the other apparatus and receives information from the other apparatus. For example, the communicator 21 may transmit, to the server 10, location information of the user terminal 20 acquired through the sensor 24, information regarding a destination set by the user, an evaluation result of a leader, or the like. In addition, the communicator 21 may receive, from the server 10, identification information regarding the leader and information for issuing various kinds of notifications to the user. Note that, the communicator 21 may receive signals for outputting such pieces of information (such as display control signals), from the server 10. In addition, the above-described information to be transmitted and received are mere examples. The present technology is not limited thereto. The communicator 21 may transmit or receive various kinds of information.

The imager 22 includes an image sensor such as a charge coupled device (CCD) or a complementary metal-oxide-semiconductor (CMOS), and captures images. The imager 22 may capture an image of, for example, a front side of the user. The imager 22 provides the captured image to the controller 25.

The input section 23 is an input interface to be used by the user for operating the user terminal 20 or for inputting information to the user terminal 20. The input section 23 may include, for example, a button, a switch, a keyboard, a pointing device, a keypad, or the like, or may include a touch sensor integrated with the display 26. In addition, the input section 23 may include a speech recognition module that detects user input on the basis of voice commands, or a gesture recognition module that detects user input on the basis of gesture commands.

The sensor 24 acquires information regarding the user holding the user terminal 20, and information regarding an ambient environment around the user terminal 20, through sensing. The sensor 24 includes at least a location sensor that acquires location information regarding the user terminal 20. Note that, the sensor 24 is not limited thereto. The sensor 24 may include various kinds of sensors such as an acceleration sensor, a gyro sensor, a microphone, a geomagnetic sensor, a ranging sensor, or a force sensor. The sensor 24 provides information acquired through sensing, to the controller 25.

The controller 25 controls operation of the respective structural elements of the user terminal 20. For example, the controller 25 controls the communicator 21 to transmit or receive various kinds of information. For example, the controller 25 may set a destination on the basis of user input obtained via the input section 23, and control the communicator 21 to transmit information regarding the destination to the server 10.

In addition, the controller 25 controls display on the display 26 on the basis of information received from the server 10 via the communicator 21. In addition, the controller 25 may control acoustic output from the acoustic output section 27 on the basis of information received from the server 10 via the communicator 21.

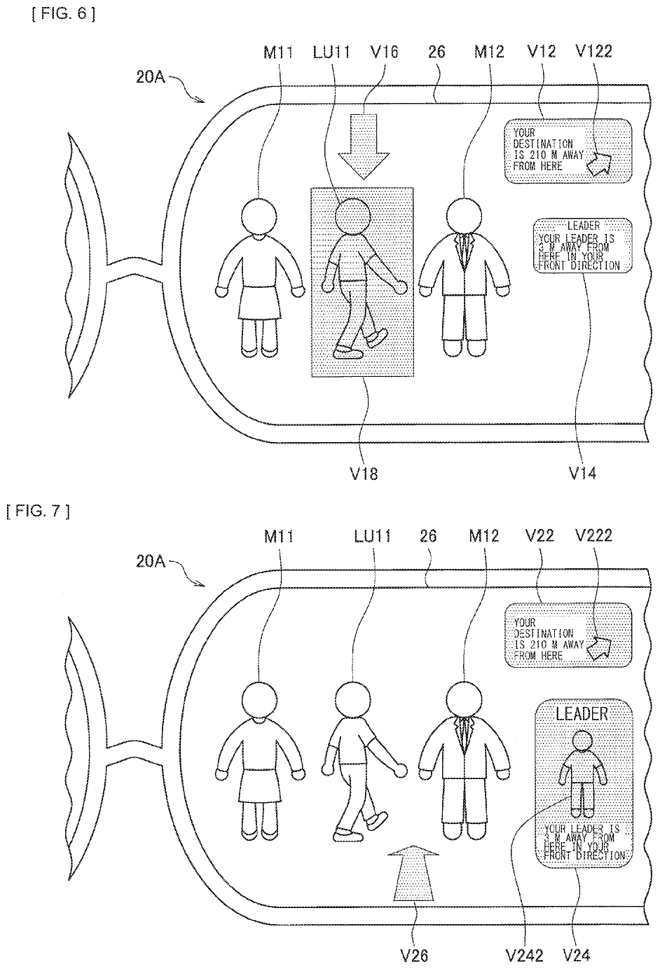

The display 26 is a display that displays various kinds of screens under the control of the controller 25. For example, the display 26 displays identification information regarding a leader. Examples of the identification information regarding the leader displayed on the display 26 will be described later with reference to FIGS. 6 to 10. Note that, the display 26 may be a see-through display, or a so-called head-up display (HUD).

The acoustic output section 27 is a speaker that outputs sound under the control of the controller 25.

The storage 28 stores programs and data to be used for operation of the user terminal 20.

The configuration of the user terminal 20 has been described above with reference to FIG. 4. However, the configuration illustrated in FIG. 4 is a mere example. The present technology is not limited thereto. For example, a certain type of user terminal 20 does not have to have a function illustrated in FIG. 4, and may have a function that is not illustrated in FIG. 4. For example, the user terminal 20 may have a vibration output function.

### 3. Operation

The configuration examples of the information processing system 1, the server 10, and the user terminal 20 according to this embodiment have been described above. Next, operation of the information processing system 1 according to this embodiment will be described. Hereinafter, operation related to the follower, operation related to the leader, and operation related to the digital signage apparatus 30 will be described in this order.

### <3-1. Operation Related to Follower>

### (Process Flow)

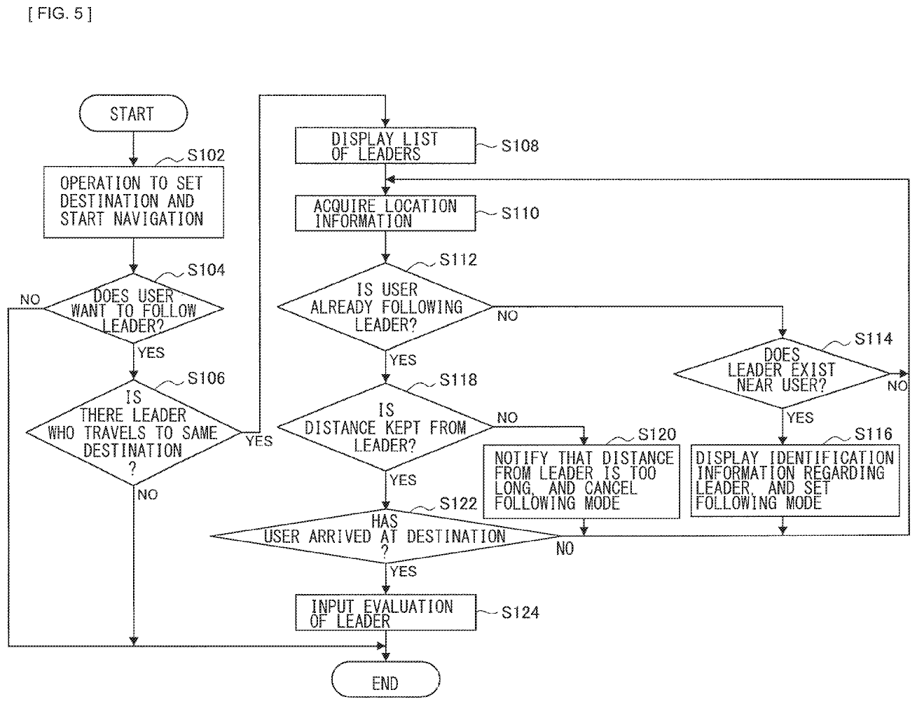

First, among operations of the information processing system 1 according to this embodiment, operation related to the follower will be described. Hereinafter, a process flow of the operation related to the follower will be described first with reference to FIG. 5, and then examples of identification information displayed on the user terminal 20 will be described with reference to FIG. 6 to FIG. 10. FIG. 5 is a flowchart illustrating a process flow of the operation related to the follower.

As illustrated in FIG. 5, a user (a follower) first operates his/her user terminal 20 to set a destination and start navigation (Step S102). Next, the user operates the user terminal 20 to select whether or not he/she wants to get navigation by following a leader (Step S104). In a case where the user does not want to get navigation by following a leader (NO in Step S104), the process ends.

In a case where the user wants to get navigation by following a leader (YES in Step S104), the controller 13 of the server 10 searches for a leader who travels to the same destination as the destination that has been set in Step S102 (Step S106). In a case where there is no leader who travels to the same destination as the destination that has been set in Step S102 (NO in Step S106), the process ends.

In a case where there are leaders who travel to the same destination as the destination that has been set in Step S102 (YES in Step S106), the user terminal 20 displays (outputs) a list of the leaders (Step S108). In Step S108, the controller 13 of the server 10 may specify, for example, all the leaders who travel to the destination, and may cause identification information regarding all the leaders to be outputted to the user terminal 20. Note that, it is also possible to select one or a plurality of leaders through user operation performed on the screen displayed in Step S108.

Next, the sensor 24 of the user terminal 20 acquires location information, and the user terminal 20 transmits the location information to the server 10 (Step S110).

Next, the controller 13 of the server 10 determines whether or not the user holding the user terminal 20 is already following the leader (Step S112). Note that, in a case where a following mode (to be described later) is set, it may be possible to determine that the user is already following the leader. For example, in a case where it is determined for the first time whether or not the user is already following the leader, it may be possible to determine that the user is not following the leader.

In a case where it is determined that the user is not following the leader (NO in Step S112), the controller 13 of the server 10 determines whether or not a leader exists near the user terminal 20 (for example, in a range of a predetermined distance) on the basis of the location information acquired in Step S110 (Step S114). In a case where a leader does not exist near the user terminal 20 (NO in Step S114), the process returns to Step S110.

In a case where leaders exist near the user terminal 20, the controller 13 of the server 10 specifies, for example, a leader who exists closest to the user terminal 20, causes identification information regarding the specified leader to be displayed on (outputted to) the user terminal 20, and sets the following mode related to the leader (Step S116). Next, the process returns to Step S110. Note that, examples of the display in Step S116 will be described later with reference to FIG. 6 to FIG. 10.

In a case where it is determined that the user is already following a leader in Step S112 (YES in Step S112), the controller 13 of the server 10 determines whether or not a distance is kept from the leader who has been specified in Step S116 (Step S118). For example, the controller 13 of the server 10 may make such a determination on the basis of the location information acquired in Step S110.

In a case where it is determined that the distance is not kept from the leader (a distance from the leader is too long) (NO in Step S118), the controller 13 of the server 10 causes information notifying that the distance from the leader is too long to be outputted to the user terminal 20 and cancels the following mode (Step S120). Note that, in a case of issuing such a notification, it is highly possible that the follower does not watch the screen of the user terminal 20. Therefore, instead of or in addition to displaying of the notification, it is desirable to output the notification acoustically or vibrationally. Next, the process returns to Step S110.

In a case where it is determined that the distance is kept from the leader (YES in Step S118), the controller 13 of the server 10 determines whether or not the user has arrived at the destination, on the basis of the location information acquired in Step S110 (Step S122). In a case where the user has not arrived at the destination (NO in Step S122), the process returns to Step S110.

In a case where the user has arrived at the destination (YES in Step S122), the navigation ends, and the user operates the user terminal 20 to input evaluation of the leader whom the user has followed (Step S124).

The example of the operation related to the follower has been described above with reference to FIG. 5. Next, with reference to FIG. 6 to FIG. 10, display examples of the identification information displayed in Step S116 described with reference to FIG. 5, will be described. Hereinafter, respective display example regarding the user terminal 20A, the user terminal 20B, the user terminal 20C that have been illustrated in FIG. 2, will be described in this order.

### (Display Example Regarding HMD)

Each of FIG. 6 to FIG. 8 is an explanatory diagram illustrating a display example of identification information on the user terminal 20A, which is the HMD worn by a user. Note that, in the examples illustrated in FIG. 6 to FIG. 8, the display 26 of the user terminal 20A is a see-through display. The display 26 makes it possible to overlay information onto a field of view of the user when the user terminal 20A is worn by the user in a manner that the display 26 is disposed in front of the eyes of the user. In the examples illustrated in FIG. 6 to FIG. 8, a leader LU11, a person M11, and a person M12 are included in the field of view of the user (follower).

As illustrated in FIG. 6, the display 26 displays destination information V12 regarding a destination, and identification information V14 for identifying the leader LU11. The destination information V12 includes a distance to the destination and an arrow V122 indicating a direction toward the destination. In addition, the identification information V14 includes information regarding a distance between the follower (the user wearing the user terminal 20A) and the leader LU11, and information regarding the direction toward the leader LU11 obtained when seen by the follower.

In addition, in a case where it is possible to analyze an image acquired by the imager 22 and detect the leader LU11 in the image, the controller 25 may cause the display 26 to display an arrow V16 indicating the leader LU11, and emphasis display V18 for emphasizing the leader LU11. Note that, the image may be analyzed by the controller 25 of the user terminal 20A, or the controller 13 of the server 10. Such a configuration makes it possible for the follower to find the LU11 leader more easily.

FIG. 7 is a display example shown in a case where the leader LU11 is not detected in an image. Note that, the case where the leader LU11 is not detected in an image includes a case where the user terminal 20A and the server 10 do not have a function of analyzing the image, and a case where the leader LU11 is not detected in the image although the user terminal 20A or the server 10 has the function of analyzing the image. In a case where the user terminal 20A or the server 10 has the function of analyzing the image, it is possible to switch the display example illustrated in FIG. 7 to the display example illustrated in FIG. 6 as soon as the leader LU11 is detected in an image.

As illustrated in FIG. 7, the display 26 may display destination information V22 regarding a destination, and identification information V24 for identifying the leader LU11. The destination information V22 includes a distance to the destination and an arrow V222 indicating a direction toward the destination.

In addition, the identification information V24 includes information regarding a distance between the follower and the leader LU11, and information regarding a direction toward the leader LU11 obtained when seen by the follower.

In addition, the identification information V24 may include a captured image V242 of the leader LU11. Such a configuration makes it possible for the follower to find the LU11 leader more easily, even in a case where the leader LU11 is not detected in an image.

In addition, as illustrated in FIG. 7, the display 26 may display an arrow V26 (an example of identification information) indicating a direction toward the leader LU11 obtained when seen by the follower. Such a configuration makes it possible for the follower to find the leader LU11 more easily, even in a case where the leader is not included in the field of view of the follower, for example.

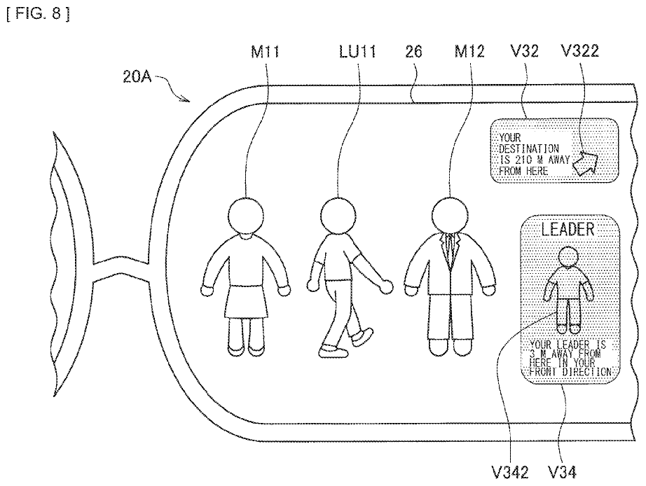

FIG. 8 is a display example shown in a case where the leader LU11 is not detected in an image and information indicating a direction toward the leader LU11 obtained when seen by the follower is not obtained. As illustrated in FIG. 8, the display 26 may display destination information V32 regarding a destination, and identification information V34 for identifying the leader LU11.

The destination information V32 includes a distance to the destination and an arrow V322 indicating a direction toward the destination. In addition, the identification information V34 includes information regarding a distance between the follower and the leader LU11. In addition, the identification information V34 may include a captured image V342 of the leader LU11. Such a configuration makes it possible for the follower to find the LU11 leader, even in a case where information indicating a direction toward the leader LU11 obtained when seen by the follower is not obtained.

### (Display Example Regarding Smartphone)

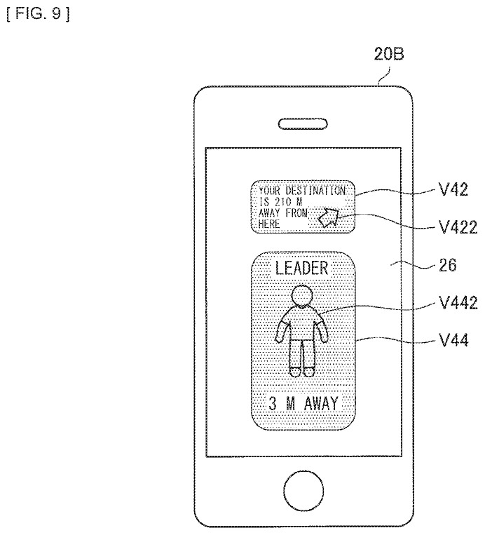

FIG. 9 is an explanatory diagram illustrating a display example of identification information on the user terminal 20B, which is a smartphone. As illustrated in FIG. 9, the display 26 may display destination information V42 regarding a destination, and identification information V44 for identifying a leader.

The destination information V42 includes a distance to the destination and an arrow V422 indicating a direction toward the destination. In addition, the identification information V44 includes information regarding a distance between the follower and the leader. In addition, the identification information V44 may include a captured image V442 of the leader.

Note that, the display example illustrated in FIG. 9 is a mere example. This embodiment is not limited thereto. For example, as in the example described above with reference to FIG. 7, the display 26 may display an arrow (an example of identification information) indicating a direction toward the leader obtained when seen by the follower. In addition, in a case where it is possible to detect the leader in an image acquired by the imager 22 included in the user terminal 20B, it is also possible for the user terminal 20B to display a screen similar to the example described above with reference to FIG. 6, by displaying a screen in which information is overlaid on the image.

### (Display Example Regarding On-Board Apparatus)

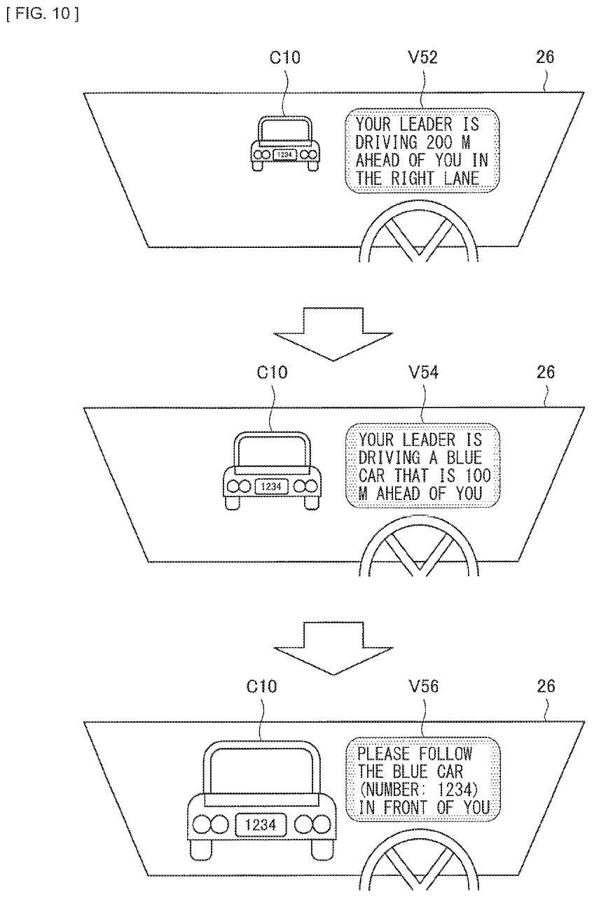

FIG. 10 is an explanatory diagram illustrating a display example of identification information on the user terminal 20C, which is an on-board apparatus installed in a vehicle such as a car. In the example illustrated in FIG. 10, the display 26 of the user terminal 20C is a see-through HUD. The display 26 makes it possible to overlay information onto a field of view of a user. In the examples illustrated in FIG. 10, a vehicle C10 a leader is in is included in the field of view of the user (follower).

As illustrated in FIG. 10, the display 26 displays identification information V52 to V56 for identifying the leader. In the examples illustrated in FIG. 10, the identification information V52 to V56 to be displayed are switched depending on a distance between an own vehicle and the vehicle C10 the leader is in. Note that, the distance between the own vehicle and the vehicle C10 may be specified on the basis of location information acquired from user terminals 20B installed in the respective vehicles.

First, in a case where the vehicle C10 in front of the own vehicle is far, the display 26 displays the identification information V52 including information regarding the distance to the leader, information regarding a direction toward the leader obtained when seen by the follower, and the like. Next, as the own vehicle approaches the vehicle C10, the information regarding the distance to the leader changes, and the display 26 displays the identification information V54 including more detailed information (such as color of the vehicle C10). In addition, in a case where the distance to the vehicle C10 becomes less than a predetermined distance, the display 26 displays the identification information V56 including an instruction to follow the vehicle C10 and more detailed information (such as numbers written on a vehicle registration plate of the vehicle C10).

Note that, FIG. 10 illustrates the examples in which the vehicle the leader is in exists in front of the own vehicle. However, in a case where the vehicle the leader is in exists behind the own vehicle, the display 26 may display information indicating that the leader is behind the own vehicle or information for instructing to slow down.

### <3-2. Operation Related to Leader>

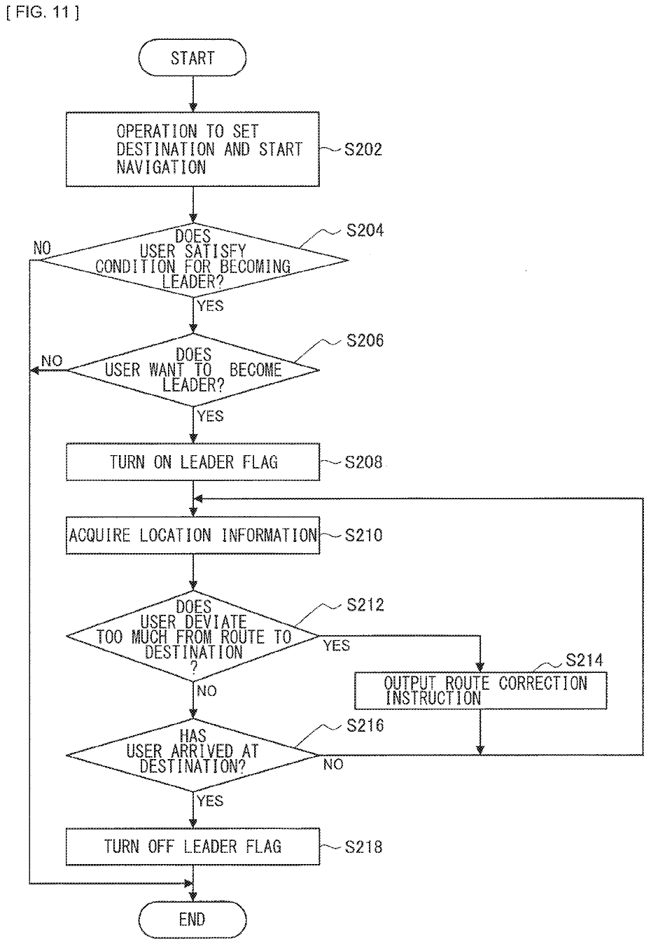

Next, operation related to a leader will be described among operations of the information processing system 1 according to this embodiment. FIG. 11 is a flowchart illustrating a process flow of the operation related to a leader.

As illustrated in FIG. 11, a user first operates his/her user terminal 20 to set a destination and start navigation (Step S202). Next, the controller 13 of the server 10 determines whether or not the user satisfies a predetermined condition for becoming a leader (Step S204). In a case where the user satisfies the predetermined condition for becoming the leader (YES in S204), the user terminal 20 is notified that the condition is satisfied, and displays a screen for prompting the user to become a leader (Step S206).

The process ends in a case where the user does not satisfy the predetermined condition for becoming the leader (NO in Step S204), or in a case where the user does not want to become the leader (NO in Step S206). Note that, in such a case, the process may proceed to Step S104 described above with reference to FIG. 5.

In a case where the user wants to become the leader (YES in Step S206), the controller 13 of the server 10 may set the user as the leader by turning on a leader flag regarding the user (Step S208).

Next, the sensor 24 of the user terminal 20 acquires location information, and the user terminal 20 transmits the location information to the server 10 (Step S210).

Next, the controller 13 of the server 10 determines whether or not the user deviates too much from a route to the destination on the basis of the location information acquired in Step S210 (Step S212). In a case where the user deviates too much from the route to the destination (YES in Step S212), the controller 13 may cause output of a route correction instruction for notifying that the user deviates too much from the route (Step S214). Note that, in a case of issuing such a notification, it is highly possible that the leader does not watch the screen of the user terminal 20. Therefore, instead of or in addition to displaying of the notification, it is desirable to output the notification acoustically or vibrationally. Next, the process returns to Step S210.

In a case where the user does not deviate too much from the route to the destination (NO in Step S212), the controller 13 of the server 10 determines whether or not the user has arrived at the destination, on the basis of the location information acquired in Step S210 (Step S216). In a case where the user has not arrived at the destination (NO in Step S216), the process returns to Step S210.

In a case where the user has arrived at the destination (YES in Step S216), the navigation ends, and the controller 13 of the server 10 turns off the leader flag of the user (Step S218).

### <3-3. Operation Related to Digital Signage Apparatus 30>

### (Process Flow)

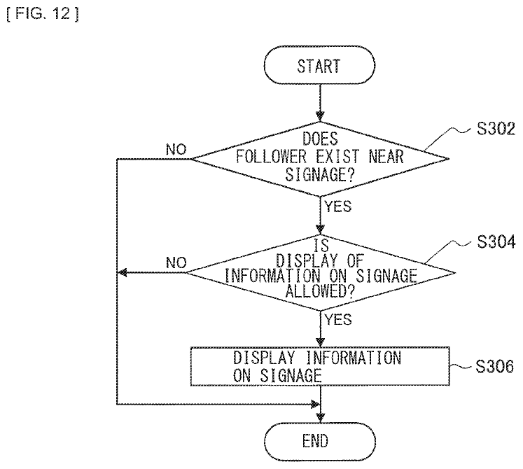

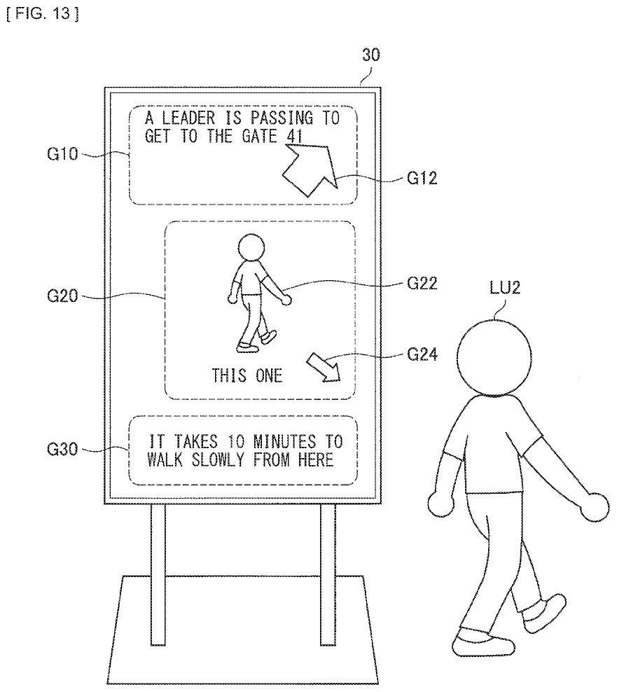

Next, operation related to the digital signage apparatus 30 will be described among operations of the information processing system 1 according to this embodiment. Hereinafter, a process flow of the operation related to the digital signage apparatus 30 will be described first with reference to FIG. 12, and then an example of identification information displayed on the digital signage apparatus 30 will be described with reference to FIG. 13. FIG. 12 is a flowchart illustrating a process flow of operation related to the digital signage apparatus 30.

First, as illustrated in FIG. 12, the controller 13 of the server 10 determines whether or not a follower exists near the digital signage apparatus 30 on the basis of location information acquired from the user terminal 20 and location information of the digital signage apparatus 30 stored in the signage DB 153 (Step S302).

In a case where a follower exist near the digital signage apparatus 30 (YES in Step S302), the controller 13 of the server 10 refers to the signage DB 153 and determines whether or not a leader traveling to a destination that is the same as a destination of the follower permits display of information on the digital signage apparatus 30 (Step S304).

In a case where no follower exists near the digital signage apparatus 30 (NO in Step S302), or in a case where the leader does not permit display of information on the digital signage apparatus 30 (NO in Step S304), the process ends.

In a case where the leader permits display of information on the digital signage apparatus 30, the controller 13 of the server 10 causes the digital signage apparatus 30 to display (output) identification information for identifying the leader (Step S306).

### (Display Example)

The example of the operation related to the digital signage apparatus 30 has been described above with reference to FIG. 12. Next, with reference to FIG. 13, a display example of the identification information displayed in Step S306 described with reference to FIG. 12, will be described. FIG. 13 is an explanatory diagram illustrating a display example of identification information on the digital signage apparatus 30. In the example illustrated in FIG. 13, a leader LU2 is passing by the digital signage apparatus 30.

As illustrated in FIG. 13, the digital signage apparatus 30 displays destination information G10, destination information G30, and identification information G20 for identifying the leader. The destination information G10 may include an arrow G12 indicating a direction toward the destination (a gate 41). In addition, the destination information G30 may include information regarding estimated time required to reach the destination.

In addition, the identification information G20 may include a captured image G22 of the leader LU2. Note that, the captured image G22 may be an image captured in advance, or may be an image captured in real time by the camera 40 installed near the digital signage apparatus 30. In addition, the identification information G20 may include an arrow G24 indicating a location of the leader. Such a configuration makes it possible for the follower to find the LU2 leader more easily.

Note that, the example illustrated in FIG. 13 is a mere example. This embodiment is not limited thereto. For example, in a case where the leader is far away from the digital signage apparatus 30, the digital signage apparatus 30 may display an image of the leader captured in real time by the camera 40 installed near the current location of the leader. Such a configuration makes it possible for the follower to easily find the leader even in a case where the follower is far away from the leader.

In addition, in the example illustrated in FIG. 13, the digital signage apparatus 30 displays only the identification information regarding the single leader LU2. However, the digital signage apparatus 30 may display identification information regarding a plurality of leaders.

### 4. Hardware Configuration

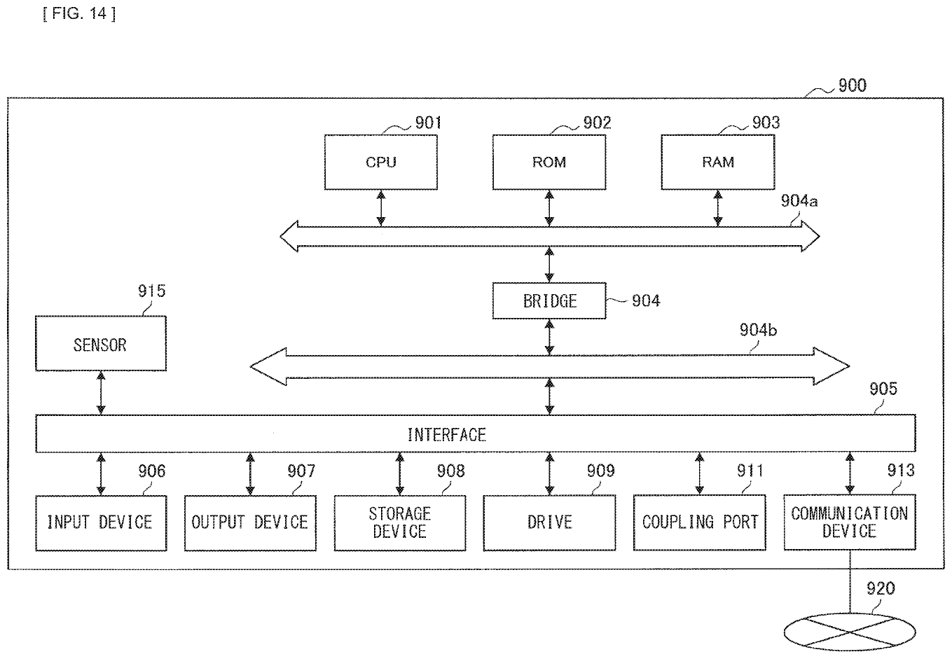

The embodiment of the present disclosure has been described above. Last of all, a hardware configuration of the information processing apparatus according to this embodiment will be described with reference to FIG. 14. FIG. 14 is a block diagram illustrating an example of a hardware configuration of the information processing apparatus according to this embodiment. Note that, for example, an information processing apparatus 900 illustrated in FIG. 14 may implement, for example, the server 10 or the user terminal 20. The server 10 and the user terminals 20 according to this embodiment achieves information processing by operating in cooperation with software and hardware to be described later.

As illustrated in FIG. 14, the information processing apparatus 900 includes a central processing unit (CPU) 901, read only memory (ROM) 902, random access memory (RAM) 903, and a host bus 904a. In addition, the information processing apparatus 900 includes a bridge 904, an external bus 904b, an interface 905, an input device 906, an output device 907, a storage device 908, a drive 909, a coupling port 911, a communication device 913, and a sensor 915. The information processing apparatus 900 may include a processing circuit such as a DSP or an ASIC instead of or in addition to the CPU 901.

The CPU 901 functions as an arithmetic processing device and a control device to control entire operation in the information processing apparatus 900 in accordance with various kinds of programs. Alternatively, the CPU 901 may be a microprocessor. The ROM 902 stores programs, arithmetic parameters, and the like to be used by the CPU 901. The RAM 903 transiently stores programs to be used when the CPU 901 is executed, parameters that change as appropriate when executing such programs, and the like. The CPU 901 may be configured as, for example, each of the controller 13 and the controller 25.

The CPU 901, the ROM 902, and the RAM 903 are coupled to each other through the host bus 904a including a CPU bus or the like. The host bus 904a is coupled, via the bridge 904, to the external bus 904b such as a peripheral component interconnect/interface (PCI) bus. Note that, the host bus 904a, the bridge 904, and the external bus 904b are not necessarily configured as separate components, but their functions may be incorporated into in a single bus.

The input device 906 is implemented by a device to which the user inputs information, such as a mouse, a keyboard, a touchscreen, a button, a microphone, a switch, or a lever. In addition, the input device 906 may be a remote controller that uses infrared ray or other electric waves, or may be externally coupled equipment such as a PDA or a mobile phone operable in response to operation of the information processing apparatus 900. Furthermore, the input device 906 may include an input control circuit or the like that generates an input signal on the basis of information inputted by a user using the aforementioned input means and outputs the generated input signal to the CPU 901. The user of the information processing apparatus 900 makes it possible to input various types of data to the information processing apparatus 900, and instruct the information processing apparatus 900 to perform processing operation, by operating the input device 906.

The output device 907 is configured as a device that makes it possible to visually or aurally notify the user of acquired information. Examples of such a device include display devices such as a CRT display device, a liquid crystal display device, a plasma display device, an EL display device, or a lamp, sound output devices such as a speaker and headphones, printer devices, or the like. The output device 907 outputs, for example, results acquired through various processes performed by the information processing apparatus 900. Specifically, the display device visually displays results acquired through various processes performed by the information processing apparatus 900, in various formats such as a text, an image, a table, or a graph. On the other hand, the sound output device converts audio signals including reproduced sound data, audio data, and the like into analog signals and aurally outputs the analog signals. The output device 907 may be configured as, for example, each of the display 26 and the acoustic output section 27.

The storage device 908 is a data storage device configured as an example of a storage of the information processing apparatus 900. The storage device 908 is implemented by, for example, a magnetic storage device such as an HDD, a semiconductor storage device, an optical storage device, a magneto-optical storage device, or the like. The storage device 908 may include a storage medium, a recording device for recording data on the storage medium, a reader device for reading data from the storage medium, a deletion device for deleting data recorded on the storage medium, and the like. The storage device 908 stores programs and various types of data to be executed by the CPU 901, various types of data acquired from an outside, or the like. The storage device 908 may be configured as, for example, each of the storage 15 and the storage 28.

The drive 909 is a reader/writer for a recording medium, and is incorporated in or externally attached to the information processing apparatus 900. The drive 909 reads information recorded on a removable recording medium such as a magnetic disk, an optical disc, a magneto-optical disk, or semiconductor memory, that is mounted thereon and outputs the information to the RAM 903. In addition, the drive 909 also makes it possible to write information to the removable storage medium.

The coupling port 911 is an interface to be coupled to external equipment, and is, for example, a coupling port for external equipment that makes it possible transmit data via a universal serial bus (USB).

The communication device 913 is, for example, a communication interface configured as a communication device or the like to be coupled to a network 920. The communication device 913 is, for example, a communication card or the like for a wired or wireless local area network (LAN), Long-Term Evolution (LTE), Bluetooth (registered trademark), or wireless USB (WUSB). In addition, the communication device 913 may be a router for optical communication, a router for asymmetric digital subscriber line (ADSL), various communication modems, or the like. For example, the communication device 913 makes it possible to transmit and receive signals and the like to and from the Internet or other communication equipment, for example, in accordance with a predetermined protocol of TCP/IP or the like. The communication device 913 may be configured as each of the communicator 11 and the communicator 21, for example.

The sensor 915 is various sensors such as an acceleration sensor, a gyro sensor, a geomagnetic sensor, an optical sensor, a sound sensor, a ranging sensor, or a force sensor, for example. The sensor 915 acquires information related to a state of the information processing apparatus 900 itself such as posture or moving speed of the information processing apparatus 900, and acquires information related to a surrounding ambient environment around the information processing apparatus 900 such as brightness or noise around the information processing apparatus 900. In addition, the sensor 915 may include a GPS sensor that receives a GPS signal and measure latitude, longitude, and altitude of the apparatus. The sensor 915 may be configured as, for example, each of the imager 22 and the sensor 24.

Note that, the network 920 is a wired or wireless communication channel through which information is transmitted from apparatuses coupled to the network 920. For example, the network 920 may include a public network such as the Internet, a telephone network, or a satellite communication network, various local area networks (LANs) including Ethernet (registered trademark), a wide area network (WAN), and the like. In addition, the network 920 may include a dedicated network such as an Internet protocol-virtual private network (IP-VPN).

The example of the hardware configuration that makes it possible to implement the functions of the information processing apparatus 900 according to this embodiment has been illustrated above. The respective structural elements described above may be implemented using general-purpose members, or may be implemented by hardware specialized for the functions of the respective structural elements. Accordingly, it is possible to change a hardware configuration to be used appropriately depending on a technical level at a time of carrying out the present embodiment.

Note that, it is possible to create a computer program for implementing each of the functions of the above-described information processing apparatus 900 according to the present embodiment and mount the computer program in a PC or the like. Furthermore, it is possible to provide a computer-readable recording medium in which such a computer program is stored. The recording medium is, for example, a magnetic disc, an optical disc, a magneto-optical disc, flash memory, or the like. Alternatively, the computer program may be distributed, for example, through a network without using the recording medium.

### 5. Conclusion

As described above, according to the embodiment of the present disclosure, it is possible to implement navigation that is safe and less affected by an ambient environment.

The preferred embodiments of the present disclosure have been described above in detail with reference to the accompanying drawings, whilst the technical scope of the present disclosure is not limited thereto. A person skilled in the art may find various alterations and modifications within the scope of the technological concept as defined by the appended claims, and it should be understood that they will naturally come under the technical scope of the present disclosure.

For example, among the functions of the controller 13 of the server 10 described in the above embodiments, some of the functions may be included in the controller 25 of the user terminal 20 or another apparatus (such as the signage apparatus 30, for example).

In addition, it is not necessary to chronologically execute respective steps according to the above described embodiments, in the order described in the flow charts. For example, the respective steps in the processes according to the above described embodiments may be processed in order different from the order described in the flow charts, or may be processed in parallel.

In addition, the effects described in the present specification are merely illustrative and demonstrative, and not limitative. In other words, the technology according to the present disclosure may exhibit other effects that are evident to those skilled in the art along with or instead of the effects based on the present specification.

Additionally, the following configuration fall within the scope of the technology of the present disclosure.

(1)

An information processing apparatus including

a controller that specifies a second user who travels to a destination that is same as a destination of a first user, and causes output of identification information for identifying the second user who has been specified.

(2)

The information processing apparatus according to (1), in which the controller causes the identification information to be outputted to a terminal associated with the first user.

(3)

The information processing apparatus according to (1) or (2), in which the second user specified by the controller is a user who satisfies a predetermined condition.

(4)

The information processing apparatus according to (3), in which the predetermined condition includes a predetermined number of visits to the destination.

(5)

The information processing apparatus according to (3) or (4), in which the controller causes information to be outputted to a terminal associated with the user who satisfies the predetermined condition out of users traveling to the destination, the information notifying that the predetermined condition is satisfied.

(6)

The information processing apparatus according to any one of (1) to (5), in which, in a case where the second user deviates too much from a route to the destination, the controller causes information to be outputted to a terminal associated with the second user, the information notifying that the second user deviates too much from the route.

(7)

The information processing apparatus according to any one of (1) to (6), in which the controller specifies the second user on the basis of a distance from the first user.

(8)

The information processing apparatus according to any one of (1) to (7), in which the controller specifies the second user on the basis of a selection made by the first user.

(9)

The information processing apparatus according to any one of (1) to (8), in which the identification information includes information regarding a distance between the first user and the second user.

(10)

The information processing apparatus according to any one of (1) to (9), in which the identification information includes information regarding a direction toward the second user obtained when seen by the first user.

(11)

The information processing apparatus according to any one of (1) to (10), in which the identification information includes a captured image of the second user.

(12)

The information processing apparatus according to any one of (1) to (11), in which the controller causes information for prompting evaluation of the second user to be outputted to a terminal associated with the first user.

(13)

The information processing apparatus according to any one of (1) to (12), in which the controller causes output of information regarding evaluation of the second user.

(14)

The information processing apparatus according to any one of (1) to (13), in which, in a case where a distance between the first user and the second user is too long, the controller causes information to be outputted to a terminal associated with the first user, the information notifying that the distance from the second user is too long.

(15)

The information processing apparatus according to any one of (1) to (14), in which the controller causes the identification information to be outputted to a digital signage apparatus.

(16)

An information processing method including:

specifying, by a processor, a second user who travels to a destination that is same as a destination of a first user; and

causing output of identification information for identifying the second user who has been specified.

(17)

An information processing system including:

an information processing apparatus including a controller that specifies a second user who travels to a destination that is same as a destination of a first user, and causes output of identification information for identifying the second user who has been specified; and

a terminal that displays the identification information.

### REFERENCE SIGNS LIST

1: information processing system
5: communication network
10: server
11: communicator
13: controller
15: storage
20: user terminal
21: communicator
22: imager
23: input section
24: sensor
25: controller
26: display
27: acoustic output section
28: storage
30: digital signage apparatus
40: camera

1. An information processing apparatus comprising
a controller that specifies a second user who travels to a destination that is same as a destination of a first user, and causes output of identification information for identifying the second user who has been specified.

2. The information processing apparatus according to claim 1, wherein the controller causes the identification information to be outputted to a terminal associated with the first user.

3. The information processing apparatus according to claim 1, wherein the second user specified by the controller is a user who satisfies a predetermined condition.

4. The information processing apparatus according to claim 3, wherein the predetermined condition includes a predetermined number of visits to the destination.

5. The information processing apparatus according to claim 3, wherein the controller causes information to be outputted to a terminal associated with the user who satisfies the predetermined condition out of users traveling to the destination, the information notifying that the predetermined condition is satisfied.

6. The information processing apparatus according to claim 1, wherein, in a case where the second user deviates too much from a route to the destination, the controller causes information to be outputted to a terminal associated with the second user, the information notifying that the second user deviates too much from the route.

7. The information processing apparatus according to claim 1, wherein the controller specifies the second user on a basis of a distance from the first user.

8. The information processing apparatus according to claim 1, wherein the controller specifies the second user on a basis of a selection made by the first user.

9. The information processing apparatus according to claim 1, wherein the identification information includes information regarding a distance between the first user and the second user.

10. The information processing apparatus according to claim 1, wherein the identification information includes information regarding a direction toward the second user obtained when seen by the first user.

11. The information processing apparatus according to claim 1, wherein the identification information includes a captured image of the second user.

12. The information processing apparatus according to claim 1, wherein the controller causes information for prompting evaluation of the second user to be outputted to a terminal associated with the first user.

13. The information processing apparatus according to claim 1, wherein the controller causes output of information regarding evaluation of the second user.

14. The information processing apparatus according to claim 1, wherein, in a case where a distance between the first user and the second user is too long, the controller causes information to be outputted to a terminal associated with the first user, the information notifying that the distance from the second user is too long.

15. The information processing apparatus according to claim 1, wherein the controller causes the identification information to be outputted to a digital signage apparatus.

16. An information processing method comprising:
specifying, by a processor, a second user who travels to a destination that is same as a destination of a first user; and
causing output of identification information for identifying the second user who has been specified.

17. An information processing system comprising:
an information processing apparatus including a controller that specifies a second user who travels to a destination that is same as a destination of a first user, and causes output of identification information for identifying the second user who has been specified; and
a terminal that displays the identification information.
